(19) United States
(12) Patent Application Publication
(10) Pub. No.: US 2022/0213297 A1
(43) Pub. Date: Jul. 7, 2022

(54) COMPOSITIONS COMPRISING FIBRILLATED CELLULOSE AND NON-IONIC CELLULOSE ETHERS

(71) Applicants: Nouryon Chemicals International B.V., Arnhem (NL); Coöperatie Koninklijke Cosun U.A., Breda (NL)

(72) Inventors: Paulus Pieter De Wit, Arnhem (NL); Conrardus Hubertus Joseph Theeuwen, Arnhem (NL); Franciscus Adrianus Ludovicus Maria Staps, Breda (NL); Gijsbert Adriaan van Ingen, Breda (NL)

(73) Assignees: Nouryon Chemicals International B.V, Arnhem (NL); Coöperatie Koninklijke Cosun U.A., Arnhem (NL)

(21) Appl. No.: 17/609,013

(22) PCT Filed: May 6, 2019
(86) PCT No.: PCT/NL2019/050269

§ 371 Date: Nov. 5, 2021

(51) Int. Cl. C08L 1/02; C08J 3/12; C08L 1/26; C09D 7/43; C09D 7/40

(52) U.S. Cl. CPC C08L 1/02; C08J 3/124; C08L 1/26; C08L 2205/02; C09D 7/70; C08J 2301/02; C09D 7/43

(57) ABSTRACT

The present invention relates to compositions comprising fibrillated cellulose and one or more nonionic cellulose ethers. Such compositions were found to be able to modify the rheology of an aqueous medium, also when the aqueous medium comprises salts and surfactants, whereby specific formulations shows desirable thixotropic thickening of the aqueous medium.

### FIELD OF THE INVENTION

The present invention relates to compositions comprising fibrillated plant and/or micro-organism derived cellulose materials that are suitable as rheology/structuring agents. More in particular the invention relates to such compositions wherein plant derived pulp is co-processed with a non-ionic cellulose ether. The invention also relates to processes to make the compositions. Furthermore the invention relates to uses of such compositions.

### BACKGROUND ART

Cellulose is a highly abundant organic polymer. It naturally occurs in woody and non-woody plant tissue, as well as in certain algae, oomycetes and bacteria. Cellulose has been used to produce paper and paperboard since ancient times. More recently cellulose (and its derivatives) gained substantial interest as rheology modifier and/or structuring agent.

Plant-derived cellulose is usually found in a mixture with hemicellulose, lignin, pectin and other substances, depending on the type of (tissue) cell from which it is derived. Plants form two types of cell wall that differ in function and in composition. Primary walls surround growing and dividing plant cells and provide mechanical strength but must also expand to allow the cell to grow and divide. Primary walls contain hemicellulose and pectin as the main constituents besides cellulose. The much thicker and stronger secondary wall, which accounts for most of the carbohydrate in biomass, is deposited once the cell has ceased to grow. The secondary walls are strengthened by the incorporation of large quantities of lignin.

In their natural form cellulose polymers stack together and form cellulose microfibrils. When the cellulose polymers are perfectly stacked together, it creates highly crystalline regions. However, disorder in the stacking will also occur leaving more amorphous regions in the microfibril. The crystalline regions in the microfibrils, and the very high aspect ratio, gives the material high strength. Various forms of processed cellulose have been developed having a much higher (relative) surface area than the cellulose raw material and therefore also a high number of accessible hydroxyl groups. Such materials have been found to possess beneficial rheological properties and have attracted much attention as viscosifying and/or structuring agents for aqueous systems in many fields of application. Important developments in this area started in the 1980's when materials were developed/disclosed by Turbak et al. (U.S. Pat. No. 4,374,702) and Weibel (EP0102829), denominated ‘Microfibrillated cellulose’ (MFC) and ‘Parenchymal cell cellulose’ (PCC) respectively.

MFC as developed by Turbak et al. was obtained from secondary cell wall celluloses through a high-energy homogenization process. MFC is typically obtained from wood pulp, e.g. softwood sulphite pulp or Kraft pulp. The pulping process removes most of the encrusting lignin and hemicellulose from the secondary cell walls, so that nanofibrous cellulose can be liberated by treatments using high mechanical shear. MFC is a tangled mass of fibres with diameters typically in the range 20-100 nm and lengths of tens of micrometers, also referred to as ‘nanofibers’.

PCC as developed by Weibel is produced from primary cell wall (parenchymal cell wall) plant materials. PCC can be obtained from agricultural processing wastes, e.g. sugar beet pulp or potato pulp. The PCC initially developed by Weibel takes the form of parenchymal cell wall fragments, from which substantially all the other components making up the primary wall (pectin and hemicellulose) have been removed. According to Weibel these fragments have to be subjected to high shear homogenization treatment so as to distend and dislocate microfibrils in the cell membrane structure, creating so-called extended or hairy membranes, which constitutes the ‘activated’ form of the material. Hereinafter, all celluloses which have been processed to give the higher surface area, including the MFC and PCC mentioned, are considered to be fibrillated celluloses (FC) which are suitable in the invention.

Even though existing FC, including MFC and PCC, initially seemed very promising, full scale production and actual commercialization has been seriously hampered. One of the challenges in commercializing FC has been to develop a product which can be shipped economically, meaning that the solids content, also known as dry matter content, is more than 50, 70, 80, 90, or 95% by weight, while still being easy redispersible in water while maintaining the rheological properties of the starting materials before drying. FC is normally produced at a very low solid content, usually at a consistency (dry matter content) of between 1% and 10% by weight, which is much too low with a view to storage and transportation costs and/or to satisfy end-user requirements. To reduce transport costs and storage requirements, higher dry matter content is needed. When the dry matter content (DM) of FC is increased however, strong aggregation and changes on the fiber surface occurs (a process often called hornification), which makes re-dispersion/re-activation after drying difficult (if not impossible). On pilot scale, FC products have been provided in a wet state, typically as ‘wet’ concentrate, having e.g. up to 50% DM. Such concentrates can still be re-activated to regain much of the initial performance. However, this requires the use of expensive equipment (such as high shear mixers) not typically available in standard formulation processes, and a substantial energy input. Additionally certain formulated products in which the FC materials are to be applied cannot accommodate the associated quantity of water and/or shear. These aspects have hampered actual (commercial-scale) use of FC.

Unsurprisingly, this problem has been the subject of substantial research efforts, as is illustrated by the teachings of Dinand (U.S. Pat. No. 5,964,983), who set out to develop a variant of Weibel's PCC that can be taken up into suspension after dehydration. According to Dinand this was accomplished by subjecting the parenchymal cell wall material to a process that, generally stated, involves less intense chemical treatment and more mechanical shear, as compared to Weibel's process. This results in a nanofibrillated product wherein some of the pectin and hemicelluloses is retained. The mechanical treatment results in the unraveling of cellulose.

In U.S. Pat. No. 6,231,657 from Cantiani et al., it is shown that the material developed by Dinand can in fact not be (easily) redispersed after dehydration/drying to (substantially) regain the beneficial rheological properties. In order to overcome these draw-back Cantiani proposes to combine Dinand's nanofibrilated product with a carboxycellulose. Similar developments and findings have been described by Butchosa et al. (Water redispersible cellulose nanofibrils adsorbed with carboxymethyl cellulose; Cellulose (2014) 21:4349-4358). As can be inferred from the experimental findings described in these documents, and as experienced by the present inventors, the materials developed by Cantiani and Butchosa et al. still suffer from various shortcomings, such as the fact that they cannot be dried to a (sufficiently) high % DM, which will cause them to be susceptible to microbiological attack, and/or require the presence of further additives (at significant amounts) and/or cannot be re-dispersed easily and/or do not regain the rheological properties of the original PCC or MFC to a satisfactory extent. More in particular, the dried mixtures of MFC and CMC do not regain their low-shear viscosity (i.e. viscosity at shear rates below 1 s⁻¹). This is evident from example 6 of U.S. Pat. No. 6,231,657, where viscosities at a shear rate below 1 s⁻¹ are determined for dried and non-dried mixtures.

In addition, these (and other) prior art teachings are limited to laboratory scale processing of cellulose and entirely fail to address the issues encountered in the development of (economically feasible) commercial scale production.

In application PCT/EP2018/080191 mixtures of FC and carboxycelluloses have been disclosed that can be dispersed easily, even after drying of the mixtures. However, the dried products were found to have reduced dispersibility rates when the aqueous medium wherein they were mixed contain one or more salts. Also a product with more thixotropic behavior is desired.

It is an object of the present invention to provide dry products that can be economically produced, are easy to disperse, and provide the desired rheological properties.

### SUMMARY OF THE INVENTION

To this end, the present inventors developed a method wherein a FC is co-processed with one or more non-ionic cellulose ethers. The methods of the present invention provide a variety of benefits, in terms of process efficiency and scalability as well as in relation to the properties of the materials obtained. For instance, it has been found that (highly) concentrated and dried products produced using the method of the invention are easily (re)dispersible in water and aqueous systems to regain much of the cellulose component's original rheological performance, also at low-shear viscosity, and in some embodiments even provide much demanded thixotropic behavior.

Without wishing to be bound by any particular theory, the inventors believe that in the compositions of the invention, the cellulose component primarily serves to confer the desired rheological/structuring properties while the non-ionic cellulose primarily serves to enable the cellulose component to be converted into a concentrated slurry, paste or powder, having low water content, that can be dispersed without the application of high mechanical shear forces while regaining most or all of the cellulose component's performance, also when dispersing is in an aqueous medium comprising salt, with a concentration of 1% by weight or more. The precise interaction between the cellulose component and the non-ionic cellulose ether and/or the way in which they ‘associate’ in the product may not be fully understood. Satisfactory results have been obtained with various combinations of cellulose components and non-ionic cellulose ethers.

Hence, one aspect of the invention thus concerns a process of producing a composition comprising a fibrillar cellulose component and nonionic cellulose ether and the process to make such compositions.

Also it was found that for specific compositions of fibrillated cellulose and non-ionic cellulose, the rheology of the resulting aqueous formulation showed unexpected rheological properties, in the sense that they were thixotropic. Hence in one aspect the invention relates to compositions comprising a fibrillar cellulose component and one or more nonionic cellulose ethers that leads to thixotropic compositions when dissolved in an aqueous medium.

In an aspect of the invention, the process to make the formulations of fibrillated cellulose and non-ionic cellulose ether comprises the steps of:

a) providing a mixture of an aqueous liquid and a plant or micro-organism derived cellulose material;
b) optionally blending a quantity of one or more carboxycellulose and/or nonionic cellulose ethers with the mixture;
c) subjecting the mixture or slurry obtained in step a) or b) to mechanical/physical treatment comprising a step wherein the cellulose is fibrillated;
d) concentrating the composition obtained in step c) to a dry matter content of at least 5 wt. %, preferably at least 10 wt. %, more preferably at least 20 wt. %;
e) optionally blending one or more nonionic cellulose ethers with the concentrate; and
f) processing the concentrate into a powder by subjecting it to a drying and milling step, whereby the milling and grinding step are one after the other in any sequence and maybe performed in one milling/grinding operation and whereby steps d) and e) can be in any order and whereby the one or more nonionic cellulose ethers are added in either step b) or e) or in both. When more than one nonionic cellulose ether is used the different nonionic cellulose ethers can be added in any order or simultaneously.
The whole process, particularly the milling and grinding is preferably conducted with limited exposure to heat.

Another aspect of the invention concerns the products that are obtainable/obtained using the processes defined herein.

In another aspect of the invention, the use of the present compositions is provided for conferring structuring and/or rheological properties in aqueous products, such as detergent formulations, for example dishwasher and laundry formulations; in personal care and cosmetic products, such as hair conditioners, hair styling products, topical crèmes, and the like; in fabric care formulations, such as fabric softeners; in paint and coating formulations as for example water-born acrylic paint formulations food and feed compositions, such as sauces, dressings, beverages, frozen products and cultured dairy; pesticide formulations; biomedical products, such as wound dressings; construction products, as for example in asphalt, concrete, mortar and spray plaster or additive packages for these construction products, such as redispersible powders; adhesives; inks; de-icing fluids; fluids for the oil & gas industry, such drilling, fracking and completion fluids; paper & cardboard or non-woven products; pharmaceutical products.

These and other aspects of the invention will become apparent on the basis of the following detailed description and the appended examples.

### DETAILED DESCRIPTION OF THE INVENTION

One aspect of the invention thus concerns a process of producing a composition comprising a cellulose component and nonionic cellulose ether; the process comprising the steps of:

a) providing a mixture of an aqueous liquid and a plant or micro-organism derived cellulose material;
b) optionally blending a quantity of one or more carboxycellulose and/or nonionic cellulose ethers with the mixture;
c) subjecting the mixture or slurry obtained in step b) to mechanical/physical and/or enzymatic activation/fibrillation treatment;
d) concentrating the composition obtained in step c) to a dry matter content of at least 5 wt. %, preferably at least 10 wt. %, more preferably at least 20 wt. %;
e) blending a further quantity of the nonionic cellulose ether with the composition as obtained in step d); and
f) processing the concentrate into a powder by subjecting it to a drying and milling/grinding operation with limited exposure to heat, preferably by subjecting the concentrate to a simultaneous thermal drying and milling/grinding operation, such as in a pneumatic mill or air turbulence mill that is temperature controlled, and whereby steps d) and e) can be in any order and whereby the one or more nonionic cellulose ethers are added in either step b) or e) or in both. When more than one nonionic cellulose ether is used the different nonionic cellulose ethers can be added in any order or simultaneously.

### Cellulose Material—Step a)

In embodiments of the invention, a slurry comprising a cellulose material is used as one of the starting materials. In accordance with the invention, the cellulose starting material is provided in the form of an aqueous slurry comprising a mixture of an aqueous liquid, typically water, and the cellulose material.

This cellulose material may originate from various sources, including woody and non-woody plant parts. For example one or more of the following cellulose-containing raw materials may be used: (a) wood-based raw materials like hardwoods and/or softwoods, (b) plant-based raw materials, such as chicory, beet root, turnip, carrot, potato, citrus, apple, grape, tomato, grasses, such as elephant grass, straw, bark, caryopses, vegetables, cotton, maize, wheat, oat, rye, barley, rice, flax, hemp, abaca, sisal, kenaf, jute, ramie, bagasse, bamboo, reed, algae, fungi and/or combinations thereof, and/or (c) recycled fibers from, for example but without limitation, newspapers and/or other paper products; and/or (d) bacterial cellulose.

As is generally understood by those skilled in the art, cellulose raw materials may be subjected to chemical, enzymatic and/or fermentative treatments that result (primarily) in the removal of non-cellulosic components typically present in parenchymal and non-parenchymal plant tissue, such as pectin and hemicellulose, in the case of parenchymal cellulose material, and lignin and hemicellulose in the case of materials derived from woody plant parts. Such treatments preferably do not result in appreciable degradation or modification of the cellulose and/or in a substantial change in the degree and type of crystallinity of the cellulose. These treatments are collectively referred to as “(bio-)chemical” treatment. In preferred embodiments of the invention, the (bio-)chemical treatment is or comprises chemical treatment, such as treatment with an acid, an alkali and/or an oxidizing agent.

In an embodiment the cellulose raw material used in the process is, or originates from, a parenchymal cell wall containing plant material. Parenchymal cell wall, which may also be denoted as ‘primary cell wall’, refers to the soft or succulent tissue, which is the most abundant cell wall type in edible plants. Suitable parenchymal cell wall containing plant material include sugar beet, citrus fruits, tomatoes, chicory, potatoes, pineapple, apple, cranberries, grapes, carrots and the like (exclusive of the stems, and leaves). For instance, in sugar beets, the parenchymal cells are the most abundant tissue surrounding the secondary vascular tissues. Parenchymal cell walls contain relatively thin cell walls (compared to secondary cell walls) which are tied together by pectin. Secondary cell walls are much thicker than parenchymal cells and are linked together with lignin. This terminology is well understood in the art. The cellulose material in accordance with the invention is suitably a material originating from sugar beet, tomato, chicory, potato, pineapple, apple, cranberry, citrus, grape and/or carrot, more preferably a material originating from sugar beet, potato and/or chicory, more preferably from sugar beet and/or chicory, most preferably from sugar beet. In an embedment of the invention the cellulose source is from cotton linters, grass, or wood, such as cellulose from a paper mill.

In certain embodiments of the invention, the slurry provided in step a) comprises a cellulose material comprising, on a dry weight basis, at least 50 wt. %, at least 60 wt. %, at least 70 wt,%, at least 75 wt. %, at least 80 wt. %, at least 85 wt. %, at least 90 wt. % or at least 95 wt. % of cellulose. In some embodiment of the invention, the cellulose component is a processed parenchymal cell cellulose material containing, by dry weight, at least 50% cellulose, 0.5-10% pectin and 1-15% hemicellulose. The term “pectin” as used herein refers to a class of plant cell-wall heterogeneous polysaccharides that can be extracted by treatment with acids and chelating agents. Typically, 70-80% of pectin is found as a linear chain of α-(1-4)-linked D-galacturonic acid monomers. It is preferred that the parenchymal cellulose material comprises 0.5-5 wt. % of pectin, by dry weight of the cellulose material, more preferably 0.5-2.5 wt. %. The term “hemicellulose” refers to a class of plant cell-wall polysaccharides that can be any of several homo- or heteropolymers. Typical examples thereof include xylane, arabinane, xyloglucan, arabinoxylan, arabinogalactan, glucuronoxylan, glucomannan and galactomannan. Monomeric components of hemicellulose include, but are not limited to: D-galactose, L-galactose, D-mannose, L-rhamnose, L-fucose, D-xylose, L-arabinose, and D-glucuronic acid. This class of polysaccharides is found in almost all cell walls along with cellulose. Hemicellulose is lower in weight than cellulose and cannot be extracted by hot water or chelating agents, but can be extracted by aqueous alkali and/or acid. Polymeric chains of hemicellulose bind pectin and cellulose in a network of cross-linked fibers forming the cell walls of most plant cells. A parenchymal cellulose material suitably comprises, by dry weight of the cellulose material, 1-15 wt. % hemicellulose, more preferably 1-10 wt. % hemicellulose, most preferably 1-5 wt. % hemicellulose.

In embodiments of the invention, the cellulose material is a (bio-)chemically treated cellulosic plant pulp comprising cellulose with a crystallinity index calculated (according to the Hermans-Weidinger method) as below 75%, below 60%, below 55%, below 50% or below 45%. In embodiments of the invention, the crystalline regions of the cellulose are primarily or entirely of the type I, which embraces types Iα and Iβ, as can be determined by FTIR spectroscopy and/or X-ray diffractometry.

In an embodiment of the invention, the cellulose material is a (bio-) chemically treated cotton linter, grass, wood, or parenchymal cellulose material, preferably a chemically and/or enzymatically treated plant pulp. In a particularly preferred embodiment the cellulose material is a material that is obtainable by a method comprising the steps of a1) providing a cellulose containing plant pulp; a2) subjecting the cellulose containing plant pulp to chemical and/or enzymatic treatment resulting in partial degradation and/or extraction of pectin and hemicellulose. Accordingly, in embodiments of the invention a process is provided as defined herein, wherein step a) comprises the steps of a1) providing a cellulose-containing pulp; a2) subjecting the pulp to chemical and/or enzymatic treatment resulting in partial degradation and/or extraction of pectin and/or hemicellulose.

The starting material typically comprises an aqueous slurry comprising ground and/or cut cellulose-containing materials, which often can be derived from waste streams of other processes, such as spent sugar beet pulp derived from conventional sugar (sucrose) production, or paper mills.

Other examples of pulps that may be employed in accordance with the present invention include, but are not limited to, pulps obtained from wood, grass, chicory, beet root, turnip, carrot, potato, citrus, apple, grape, or tomato, preferably pulps obtained from chicory, beet root, turnip, carrot or potato. In one embodiment the use of potato pulp obtained after starch extraction is envisaged. In another embodiment of the invention, the use of potato peels, such as obtained in steam peeling of potatoes, is envisaged. In some embodiments, the use of press pulp obtained in the production of fruit juices is envisaged.

In accordance with the invention, the (bio-)chemical treatment of step a2) results in the degradation and/or extraction of at least a part of the pectin and hemicelluloses present in the pulp, typically to monosaccharides, disaccharides and/or oligosaccharides, typically containing three to ten covalently bound monosaccharides. However, as indicated above, the presence of at least some pectin, such as at least 0.5 wt. %, and some hemicellulose, such as 1-15 wt. %, is sometimes desired. As will be understood by those skilled in the art, said pectin and hemicellulose remaining in the cellulose material can be non-degraded and/or partially degraded. Hence, step a2) typically comprises partial degradation and extraction of the pectin and hemicellulose, preferably to the extent that at least 0.5 wt. % of pectin and at least 1 wt. % of hemicellulose remain in the material. It is within the routine capabilities of those skilled in the art to determine the proper combinations of reaction conditions and time to accomplish this.

Suitably, the chemical treatment as mentioned in step a2) of the above mentioned method comprises:
mixing the pulp with alkaline metal hydroxide to a final concentration of 0.1-1.0 M, preferably 0.3-0.7 M of the hydroxide; and
heating the pulp and alkaline metal hydroxide to a temperature within the range of 60-120° C., e.g. 80-120° C., for a period of at least 10 minutes, preferably at least 20 minutes, more preferably at least 30 minutes.

The use of alkaline metal hydroxides, especially sodium hydroxide, in the above method, is advantageous to efficiently remove pectin, hemicelluloses and proteins from the cellulose. The alkaline metal hydroxide may be sodium hydroxide. The alkaline metal hydroxide may be potassium hydroxide. The alkaline metal hydroxide may be mixed with the parenchymal cell containing plant pulp to a concentration of at least 0.1 M, at least 0.2 M, at least 0.3 M, or at least 0.4 M of the hydroxide. The alkaline metal hydroxide concentration preferably is at less than 0.9 M, less than 0.8 M, less than 0.7 M or less than 0.6 M. The use of relatively low temperatures in the present chemical process allows the pulp to be processed with the use of less energy and therefore at a lower cost than methods known in the art employing higher temperatures. In addition, use of low temperatures and pressures ensures that minimum cellulose nanofibers are produced. The pulp may be heated to at least 60° C., or at least 80° C. Preferably, the pulp is heated to at least 90° C. Preferably, the pulp is heated to less than 120° C., preferably less than 100° C. As will be appreciated by those skilled in the art, the use of higher temperatures, within the indicated ranges, will reduce the processing times and vice versa. It is a matter of routine optimization to find the proper set of conditions in a given situation. As mentioned above, the heating temperature is typically in the range of 60-120° C., e.g. 80-120° C., for at least 10 minutes, preferably at least 20 minutes, more preferably at least 30 minutes. If the heating temperature is between 80-100° C., the heating time may be at least 60 minutes. Preferably, the process comprises heating the mixture to a temperature of 90-100° C. for 60-120 minutes, for example to a temperature of approximately 95° C. for 120 minutes. In another embodiment of the invention, the mixture is heated above 100° C., in which case the heating time can be considerably shorter. In a preferred embodiment of the present invention the process comprises heating the mixture to a temperature of 110-120° C. for 10-50 minutes, preferably 10-30 minutes.

In an embodiment a wood pulp resulting from a Kraft process is used.

In an embodiment of the invention, at least a part of the pectin and hemicelluloses may be degraded by treatment of the pulp with suitable enzymes. Preferably, a combination of enzymes is used, although it may also be possible to enrich the enzyme preparation with one or more specific enzymes to get an optimum result. Generally an enzyme combination is used with a low cellulase activity relative to the pectinolytic and hemicellulolytic activity. The enzyme treatments are generally carried out under mild conditions, e.g. at pH 3.5-5 and at 35-50° C., typically for 16-48 hours, using an enzyme activity of e.g. 65.000-150.000 units/kg substrate (dry matter). It is within the routine capabilities of those skilled in the art to determine the proper combinations of parameters to accomplish the desired rate and extent of pectin and hemicellulose degradation.

It is particularly beneficial to subject the mass resulting from step a2) to treatment with an acid. Typically sulphuric acid is used, but the use of other acids, such as HCl and HNO₃ can be beneficial, depending on the anions that are preferred. This step typically is performed to dissolve and optionally remove various salts from the material. It was found that by applying this step, the material eventually obtained has improved visual appearance in that it is substantially more white.

The treatment of step a2) may comprise the additional step of mixing the treated pulp with an acid in an amount to lower the pH to below 4, preferably below 3, more preferably below 2. In preferred embodiments of the invention, the pH of the mass is never below 0.5 during step a2) and/or during any step in the process, more preferably it is not below 1.0 during step a2) and/or during any step in the process. In a preferred embodiment, said acid is sulphuric acid. In preferred embodiments of the invention, the temperature of the mass is kept below 100° C., preferably below 95° C., more preferably below 90° C., most preferably below 85° C. during the acid treatment. In preferred embodiments of the invention, conditions are chosen that do not result in hydrolysis of the amorphous regions of the cellulose polymer to any significant extent. Hence, in preferred embodiments of the invention, step a2) is carried out in such a way that the reduction in average degree of polymerization DPₐᵥ is less than 50%, preferably less than 40%, less than 30%, less than 20% or less than 10%. Furthermore, in preferred embodiments of the invention, step a2) is carried out in such a way that the increase in crystallinity index calculated (according to the Hermans-Weidinger method) is less than 50%, preferably less than 40%, less than 30%, less than 20% or less than 10%.

Typically, the process of this invention will only include one acid treatment step. The acid treatment of the pulp was found to allow for even milder alkaline treatment of the material in step a2) of the present process. The acid treatment may be applied prior to as well as after the alkaline treatment. In a preferred embodiment of the invention, the acid treatment is applied prior to the alkaline treatment.

Hence, in a preferred embodiment of the invention, the chemical treatment of step a2) of the above mentioned method comprises:
mixing the pulp with an amount of acid to lower the pH value to within the range of 0.5-4, more preferably 1-3, and heating the parenchymal cell containing plant pulp to a temperature within the range of 60-100° C., e.g. 70-90° C., for a period of at least 10 minutes, preferably at least 20 minutes, more preferably at least 30 minutes; and.
mixing the pulp with alkaline metal hydroxide to increase the pH to a value within the range of 8-14, more preferably 10-12, and heating the mixture of pulp and alkaline metal hydroxide to a temperature within the range of 60-100° C., e.g. 70-90° C., for a period of at least 10 minutes, preferably at least 20 minutes, more preferably at least 30 minutes.

It will be understood that the (bio-)chemically treated pulp may suitably be subjected to one or more washing steps after any of the (bio-)chemical treatments, so as to wash out the acids, alkali, oxidizing agents, salts, enzymes and/or degradation products. Washing can be accomplished simply by subjecting the pulp or slurry to mechanical dewatering treatments, using e.g. a filter press and taking up the ‘retentate’ in fresh (tap) water, an acid or alkali, as is suitable. As will be understood by those skilled in the art, the pulp can be dewatered quite easily at this stage of the process as it has not yet been activated (fibrillated). In preferred embodiments of the invention, after the treatment with the alkali and/or enzyme and, optionally, the acid, has been completed, the treated pulp obtained accordingly is subjected to washing and is taken up in a quantity of aqueous liquid, such as (tap) water, to obtain the aqueous slurry comprising a mixture of a aqueous liquid and cellulose material, having the appropriate wt. % of the cellulose material as specified herein elsewhere.

Optional Addition of Carboxycellulose and/or Nonionic Cellulose Ether—Step b)

In step b) of the present process, the slurry provided in step a) is optionally blended with carboxycellulose and/or nonionic cellulose ether.

As used herein, the term carboxycellulose refers to derivatives of cellulose comprising carboxylic acid groups bound to some of the hydroxyl groups of the cellulose monomers, usually by means of a linking group, whereby the anionic carboxy groups which typically render the derivative to become water soluble. In accordance with the invention, the carboxycellulose preferably is carboxymethylcellulose (CMC), although other variants may also suitably be used. The carboxylic acid groups may also be (partially) present in the salt and/or ester form. Suitably the sodium salt of a carboxycellulose is used. All of such compounds are herein defined to be anionic. Suitable carboxycellulose products are commercially available, such as the Akucell®, Depramin®, Peridur®, Staflo®, Gabroil® and Gabrosa® product ranges from Nouryon.

As used herein, the term nonionic cellulose ether refers to derivatives of cellulose comprising non-ionic groups bound to some of the hydroxyl groups of the cellulose monomers, usually by means of a linking group. The cellulose ethers as used in accordance with the invention can be selected from conventional nonionic cellulose ethers, such as from the group consisting of methylcellulose, ethylcellulose, hydroxyethylcellulose, hydrophobically modified hydroxyethylcellulose, hydroxypropylcellulose, hydrophobically modified hydroxypropylcellulose, hydroxyethylhydroxypropylcellulose, hydrophobically modified hydroxyethyl-hydroxypropylcellulose, methylhydroxyethylcellulose, hydrophobically modified methylhydroxyethylcellulose, methylhydroxypropylcellulose, hydrophobically modified methylhydroxypropyl-cellulose, methylhydroxyethylhydroxy-propylcellulose, hydrophobically modified methylhydroxyethylhydroxypropyl-cellulose, ethylhydroxyethylcellulose, hydrophobically modified ethylhydroxy-ethylcellulose, methylethylhydroxyethylcellulose, and hydro-phobically modified methylethylhydroxyethylcellulose. Suitably the cellulose ether is chosen from hydroxyethylcellulose, ethylhydroxyethylcellulose, methylhydroxyethylcellulose, methylethylhydroxy-ethylcellulose, methylhydroxypropylcellulose, or their hydrophobically modified derivatives. Any of the nonionic cellulose ethers may also be (temporarily) crosslinked, as for instance with glyoxal and/or one or more products of the formula (C₁₋₄ alkyl)-OC(O)CHOHO—(C₁₋₄ alkyl). Also any mixture of any of the above-identified cellulose ethers can be used, whereby the various types of cellulose ethers can be introduced in the formulation in any order. Such cellulose ethers are commercial and can be produced according to known processes. The reaction of the cellulose raw material and the lye (typically NaOH) and etherifying agents can be in horizontal or vertical reactors and can be a “dry-flock” or “slurry” process, depending on the amount of aqueous medium used in the process. The aqueous medium can contain conventional co-media, such as C₁₋₅ alcohols and C₂₋₅ carbonates. The cellulose raw material is typically grinded before use to improve homogeneous reactions. During grinding the cellulose is suitably cooled to prevent hornification. Also the cellulose grinding capacity was found to be increased due to the cooling. When a nonionic cellulose ether with ethyl-oxy substituents on the backbone is produced, than typically ethyl chloride is a reactant. When ethyl chloride is used, it is suitably added after the reactor is freed from air, typically by a vacuum step, such that the pressure is increased and oxygen is prevented from re-entering into the reactor. An etherification agent that is often used is ethylene oxide. When the ethylene oxide is dosed during (part of) the process, then the dosing rate is suitably selected to be about the same as the reaction rate (e.g. by measuring the pressure inside the reactor) to allow a better temperature control and improve the product quality. However, (part of) the ethylene oxide can also be reacted first, for instance to use the heat of reaction to heat up the reactor content, for instance to conventional temperatures of about 110° C., to minimize heating and cooling costs. The process to produce the nonionic cellulose ether suitably comprises a distillation and/or extraction step to remove unreacted etherification agents, such as methyl and/or ethyl chloride and co-media. Suitably the etherification agent and/or co-media are recycled to the process to make the nonionic cellulose ether. After the reaction the cellulose ether is suitably milled and dried using conventional equipment as also described herein for the mixtures. Suitably a milling/grinding step is followed by a classification step to obtain a product with the desired particle size. As is known in the art, classification can be with sieves or by air-classifiers. Suitably the cellulose ether is cooled during handling to prevent lumping of the product and clogging of operations. Suitably the cellulose ether is supplied in bags which prevent moisture from entering the bag to prevent lumping, such as conventional PE lamellar and “labyrinth” bags.

To obtain the desirable mixtures that provide thixotropic aqueous formulations after the products are redispersed in an aqueous medium, the cellulose ether is suitably chosen from hydroxyethylcellulose, ethylhydroxyethylcellulose, methylhydroxyethylcellulose, methylethylhydroxy-ethylcellulose, methylhydroxypropylcellulose, or their hydrophobically modified derivatives.

As will be apparent to those of average skill in the art, suitable nonionic cellulose ethers are commercial grades, such as the Bermocoll®, product range from Nouryon.

The molecular weight of the nonionic cellulose ether, expressed as the weight averaged molecular weight (Mw), is not very critical. The Mw is determined in duplicate in a conventional way by Size Exclusion Chromatography using samples that were dissolved in water and filtered before injection (100 μl) to the SEC system fitted with two columns of the type TSK GMPWXL 7.8×300 mm ex Sigma-Aldrich and a pre column. The mobile phase is a 0.05 M sodium acetate solution at pH=6 with 0.02% NaN3 with a flow of 0.5 ml/min. Column Temp. 35° C. Using a refractive index, light scattering, and viscosity (TDA) detectors and applying a dn/dc of 0.148.

Suitably products ranging from very low viscosity grades with a typical Mw of 2.000 Dalton up to ultra-high viscosity grades, such as those with a Mw of 10,000.000 Dalton, are used. In an embodiment the Mw is less than 2,500,000, 1,000,000, 500,000, 350,000, 250,000 or 200,000 Dalton for ease of dissolution. In an embodiment the Mw is more than 5,000, 20,000, 75,000, 125,000, 150,000, or more than 175,000 for higher viscosity of the end-product after dissolution. To obtain the desirable mixtures that provide thixotropic aqueous formulations after the products are redispersed in an aqueous medium, the molecular weight is suitably greater than 100,000 or 200,000 Dalton. The molecular weight of the cellulose ether can be influenced by the oxygen levels in the reactor when making the cellulose ether, with higher oxygen levels reducing the molecular weight. To obtain the desirable mixtures that provide thixotropic aqueous formulations after the products are redispersed in an aqueous medium, suitably a (temporarily) crosslinked cellulose ether is used. In embodiments of the invention, the nonionic cellulose ether is added in the solid form, suitably as pure nonionic cellulose ether, or dissolved in a suitable quantity of aqueous liquid, such as (tap) water. The latter can make the process of blending the cellulose material and the nonionic cellulose ether more efficient. In embodiments of the invention, step b) comprises adding to the aqueous slurry provided in step a) an aqueous solution comprising dissolved therein the carboxycellulose and/or nonionic cellulose ether, typically at a level of 1-10 wt. %, 2-7.5 wt. %, or 3-6 wt. %.

In embodiments of the invention, the blended composition produced in step b) comprises, on a dry solids weight basis, at least 1.0 wt. %, at least 1.5 wt. %, at least 2.0 wt. %, at least 2.5 wt. %, at least 3.0 wt. %, at least 4.0 wt. %, or at least 5 wt. % of carboxycellulose and/or nonionic cellulose ether. In embodiments of the invention, the blended composition produced in step b) comprises, on a dry solids weight basis, at least 6 or at least 7 wt. % of nonionic cellulose ether. In embodiments according to the invention, the blended composition produced in step b), comprises, on a dry solids weight basis, less than 80 wt. %, less than 75 wt. %, less than 70 wt. %, less than 65 wt. %, or less than 60 wt. % of the nonionic cellulose ether. In embodiments according to the invention, the blended composition produced in step b), comprises, on a dry solids weight basis, less than 55 wt. %, or less than 50 wt. % of the nonionic cellulose ether.

In embodiments of the invention, the blended composition produced in step b) comprises, on a dry solids weight basis, less than 99 wt. %, less than 98.5 wt. %, less than 98 wt. %, less than 97.5 wt. %, less than 97 wt. %, less than 96 wt. %, or less than 95 wt. % of the cellulose material. In embodiments according to the invention, the blended composition produced in step b), comprises, on a dry solids weight basis, more than 50 wt. %, more than 65 wt. %, more than 70 wt. %, more than 75 wt. %, or more than 80 wt. % of the cellulose material.

In embodiments of the invention, the blended composition produced in step b) comprises the cellulose material and the nonionic cellulose ether in a ratio (w/w) of from 95/5 to 5/95, 90/10 to 10/90, or within the range of 80/20 to 20/80.

In embodiments of the invention, a homogeneous slurry of the nonionic cellulose ether and the cellulose material is produced using e.g. conventional mixing or blending equipment, typically mixing or blending equipment exerting low mechanical shear.

As will be understood by those skilled in the art, the addition of the nonionic cellulose ether as an aqueous solution inherently reduces the (relative) amount of the cellulose material to some extent. Hence, this step can be used to further adjust the content of the cellulose material to the level appropriate for the activation/fibrillation treatment. The appropriate level may depend on the technique used to perform the activation treatment.

In accordance with a preferred embodiment of the invention, wherein the activation/fibrillation is performed using high shear homogenization, a slurry is produced/obtained in step b) having a content of the cellulose material, based on the total weight of the slurry, of less than 20 wt. %, less than 15 wt. % or less 10 wt. %. In embodiments of the invention, the content of the cellulose material, based on the total weight of the slurry, is at least 0.5 wt. %, at least 1.0 wt. %, at least 1.5 wt. %, at least 1.75 wt. %, or at least 2.0 wt. %. In embodiments of the invention, the content of the cellulose material, based on the total weight of the slurry, is less than 9.0 wt. %, less than 8.0 wt. %, less than 7.0 wt. %, less than 6.0 wt. %, less than 5.0 wt. %, less than 4.5 wt. %, less than 4 wt. %, less than 3.5 wt. %, less than 3 wt. %, or less than 2.5 wt. %.

Embodiments are also envisaged wherein the mechanical and/or physical activation/fibrillation treatment is performed using refining equipment specifically designed to process slurries containing more than 0.5 wt. % or more than 1 wt. % of cellulose material, such as described in WO 2017/103329. This may improve the efficiency of the processing in various way. For instance, the concentrating step after the activation/fibrillation treatment may become superfluous. Hence, In accordance with a preferred embodiment of the invention, wherein the activation/fibrillation is performed using e.g. refining equipment, such as the equipment described in WO 2017/103329, a slurry is produced/obtained in step b) having a content of the cellulose material as presented above.

### Activation of the Cellulose—Step c)

Subsequently, the homogeneous slurry is subjected to (generally known) treatments, typically involving subjecting the cellulose material to high mechanical or physical (shear) forces, that alter the morphology of the cellulose, typically through the partial, substantial or complete liberation of cellulose microfibrils from the cellulose fiber structure and/or the opening up of the cellulose fiber network structure, thereby significantly increasing the specific surface area thereof. This treatment may be referred to as the ‘activation’ treatment, whereby the cellulose material actually gains its beneficial rheological profile. Such treatments are referred to herein as “mechanical/physical fibrillation treatment” or “mechanical/physical activation treatment” (or the like). As is known by those skilled in the art, similar changes in the morphology and/or functional properties of the cellulose material can be brought about using certain enzymatic procedures, known as HefCel treatment. This treatment is referred to herein as “enzymatic fibrillation treatment” or “enzymatic activation treatment”.

In some embodiments of the invention the mechanical and/or physical treatment is applied to produce a fibrillated cellulose (FC) material. The term “fibrillated cellulose (FC)” in the context of the present invention is defined as cellulose consisting (substantially) of microfibrils in the form of either isolated cellulose microfibrils and/or microfibril bundles of cellulose, both of which are derived from a cellulose raw material, including conventional microfibrillated cellulose (MFC). FC microfibrils typically have a high aspect ratio. Fibrillated cellulose fibers typically have a diameter of 10-300 nm, preferably 25-250 nm, more preferably 50-200 nm, and a length of several micrometers, preferably less than 500 μm, more preferably 2-200 μm, even more preferably 10-100 μm, most preferably 10-60 μm. Fibrillated cellulose comprises often bundles of 10-50 microfibrils. Fibrillated cellulose may have high degree of crystallinity and high degree of polymerization, for example the degree of polymerisation DP, i.e. the number of monomeric units in a polymer, may be 100-3000. As used herein, “microfibrillated cellulose” can be used interchangeably with “microfibrillar cellulose”, “nanofibrillated cellulose”, “nanofibril cellulose”, “nanofibers of cellulose”, “nanoscale fibrillated cellulose”, “microfibrils of cellulose”, and/or simply as “FC”. Additionally, as used herein, the terms listed above that are interchangeable with “microfibrillated cellulose” may refer to cellulose that has been completely microfibrillated or cellulose that has been substantially microfibrillated but still contains an amount of non-microfibrillated cellulose at levels that do not interfere with the benefits of the microfibrillated cellulose as described and/or claimed herein, typically comprising less than 30% by weight of non-microfibrillated cellulose.

In some embodiments of the invention, the mechanical and/or physical treatment is applied to reduce the particle size of the cellulose material so as to yield a particulate material or cellulose fine material having a characteristic size distribution. When the distribution is measured with a laser light scattering particle size analyzer, such as the Malvern Mastersizer or another instrument of equal or better sensitivity, the diameter data is preferably reported as a volume distribution. Thus the reported median for a population of particles will be volume-weighted, with about one-half of the particles, on a volume basis, having diameters less than the median diameter for the population. Typically, the slurry is treated so as to obtain a particulate composition having a reported median major dimension (D[4,3]), within the range of 15-75 μm, as measured using laser diffraction particle size analysis. A suitable apparatus for this (and other) particle size characteristics is a Malvern Mastersizer 3000 obtainable from Malvern Instruments Ltd., Malvern UK, using a Hydro MV sample unit (for wet samples). In preferred embodiments of the invention, the slurry is treated so as to obtain a composition having a reported median major dimension within the range of 20-65 μm or 25-50 μm. Typically, the reported D90 is less than 120 μm, more preferably less than 110 μm, more preferably less than 100 μm. Typically the reported D10 is higher than 5 μm, more higher than 10 μm, more preferably higher than 25 μm. In an embodiment, In accordance with certain embodiments, the mechanical and/or physical treatment does not result in the complete or substantial unraveling to nanofibrils.

Furthermore, the invention provides embodiments wherein a mechanical and/or physical treatment is applied whereby the specific surface of the cellulose material, as determined using a Congo red dye adsorption method (Goodrich and Winter 2007; Ougiya et al. 1998; Spence et al. 2010b), is increased. In some embodiments of the invention, said specific surface area is at least 30 m²/g, at least 35 m²/g, at least 40 m²/g, at least 45 m²/g, at least 50 m²/g, or at least 60 m²/g. In some embodiments of the invention, said specific surface area is at least 4 times higher than that of the untreated (i.e. non-shear-treated) cellulose, e.g. at least 5 times, at least 6 times, at least 7 times or at least 8 times.

To accomplish the desired structure modification a high mechanical shear treatment is preferably applied. Examples of suitable techniques include high pressure homogenization, microfluidization and the like. Most preferred examples of high shear equipment for use in step b) include friction grinders, such as the Masuko supermasscolloider; high pressure homogenizers, such as a Gaulin homogenizer, high shear mixers, such as the Silverson type FX; in line homogenizers, such as the Silverson or Supraton in line homogenizer; and microfluidizers. The use of this equipment in order to obtain the particle properties in accordance with some embodiments of this invention is a matter of routine for those skilled in the art. The methods described here above may be used alone or in combination to accomplish the desired structure modification.

In preferred embodiments of the invention, the mechanical and/or physical treatment is performed using a high pressure homogenization wherein the material is passed over the homogenizer operated at a pressure of 50-1000 bar, preferably at 70-750 bar or 100-500 bar. In embodiments of the invention, the slurry is passed through said apparatus a number of times. In such embodiments, the mechanical and/or physical treatment comprises 2, 3, 4, 5, 6, 7, 8, 9 or 10 passes of the slurry through said apparatus while operating at suitable pressures as defined here above. It will be apparent to those of average skill in the art that the two variables of operating pressure and number of passes are interrelated. For instance, suitable results will be achieved by subjecting the slurry to a single pass over the homogenizer operated at 500 bar as well as by subjecting the slurry to 6 passes over the homogenizer operated at 150 bar. It is within the routine capabilities of the person skilled in the art to make appropriate choices, the suitability of which can be verified by subjecting the homogenized slurry to particle size analysis in accordance with what is defined here above.

In other preferred embodiments of the invention, the mechanical and/or physical activation/fibrillation treatment is performed using refining equipment specifically designed to process slurries containing more than 10 wt. % or more than 20 wt. % of cellulose material. An example of an apparatus that is particularly suitable for that purpose is a rotor-stator or (counter-rotating) rotor-rotor refiners such as described in U.S. Pat. No. 6,202,946. This type of apparatus is manufactured by Megatrex Oy and sold under the brand Atrex®. Refining at high consistency may further improve the efficiency of the processing in various ways. For instance, less water will need to be removed in the concentrating step following the activation/fibrillation treatment.

Hence, in an embodiment of the invention, step a) of the process defined herein comprises:

a) providing a mixture of an aqueous liquid and a plant or micro-organism derived cellulose material;
b) optionally blending a quantity of nonionic cellulose ether with the mixture;
c) subjecting the material resulting from step b) to mechanical/physical activation/fibrillation treatment, while having a dry matter content of at least 10 wt. %, at least 12 wt. %, at least 14 wt. % at least 15 wt. %, at least 16 wt. %, at least 17 wt. %, at least 18 wt. %, at least 19 wt. % or at least 20 wt. %, using a refining apparatus suitable for refining cellulose at high consistency, in particular a rotor-stator refining apparatus or a rotor-rotor refining apparatus; and
d) further concentrating the material as obtained in step c);
e) optionally blending a quantity of nonionic cellulose ether with the mixture;
f) drying and grinding (in one step or in any order) the product of step e) in order to obtain a dry powder;
whereby steps d) and e) can be taken in any order and whereby the nonionic cellulose ether is added in step b) or e) or both.

As indicated herein before, the high mechanical shear treatment of step c) may be performed using other types of equipment and it will be within the skilled person's (routine) capabilities to determine operating conditions resulting in equivalent levels of mechanical shear.

### Dewatering—Step d)

In accordance with embodiments of the invention, the activation/fibrillation treatment of step c) is followed by a step d) wherein at least part of the water is removed. Preferably step d) is a mechanical or non-thermal dewatering treatment. In one preferred embodiment of the invention step d) comprises filtration, e.g. in a chamber filter press. In an embodiment a membrane is used in the process to remove water. The removal of water may aid in the removal of a substantial fraction of dissolved organic material as well as a fraction of unwanted dispersed organic matter, i.e. the fraction having a particle size well below the particle size range of the particulate cellulose material. Preferably, step d) of the process does not involve or comprise a thermal drying or evaporation step, since such steps are uneconomical and/or can lead to hornification of the cellulose.

As will be understood by those skilled in the art, it is possible to incorporate multiple processing steps in order to achieve optimal results. For example, an embodiment is envisaged wherein the mechanical treatment of step b) is followed by subjecting the mixture to microfiltration, dialysis or centrifuge decantation, or the like, followed by a step of pressing the composition. As will be understood by those skilled in the art, the removal of water in step d) may also comprise the subsequent addition of water or liquid followed by an additional step of removal of liquid, e.g. using the above described methods, to result in an additional washing cycle. This step may be repeated as many times as desired in order to achieve a higher degree of purity.

In accordance with the invention, in step d), the slurry obtained in step c) is concentrated to a dry matter content of at least 5 wt. %, at least 10 wt. %, preferably at least 15 wt. %, at least 20 wt. %, at least 25 wt. % or at least 30 wt. %.

Based on the present teachings, it will be understood by those skilled in the art, that the concentration step may not be needed to reach the aforementioned target dry matter levels in case the activation/fibrillation treatment is performed on a mixture with high cellulose material content. In such cases the concentration step may be omitted. It is also envisaged that even in such embodiments a concentration step can be performed nonetheless to reach relatively high dry matter levels, such as at least 20 wt. %, at least 25 wt. % or at least 30 wt. %.

### Blending Additional Quantity of Nonionic Cellulose Ether—Step e)

In accordance with the invention, step d) is optionally followed by a step e) comprising the addition of nonionic cellulose ether to the composition before or after step d). If in step b) no nonionic cellulose ether was used, i.e. if no cellulose was used or only CMC, then in this step e) a nonionic cellulose ether must be used. If nonionic cellulose ether was used in step b) then an additional mount of nonionic cellulose ether can be used in this step. In an embodiment the amount of cellulose material and the amount of nonionic cellulose ether in the blend resulting from step d) is the same as defined above for step b). The nonionic cellulose ether that is used can have any suitable particle size. Typically the particles size of the cellulose ether, as produced in a conventional process, passes a 280 mesh screen. Larger particles can be produced in the conventional process, typically increasing capacity, but this typically leads to lower product quality, i.e. after dispersing of the cellulose ether more gels will be observed in the resulting dispersion. Smaller particles can be used as they tend to give lower amounts of gels, but then the milling of the cellulose ether will adversely affect the milling capacity and increase the milling costs.

The nonionic cellulose ether can be added to the mixture in the same way as presented in step b). Suitably, the additional quantity of the nonionic cellulose ether is homogeneously blended with the composition comprising the fibrillated cellulose. This can be done with any suitable industrial mixing or kneading system. Such systems can be continuous or batch-wise. Suitable continuous mixers can be single or double shafted and co- or counter current. A suitable equipment is an extruder, preferably with mixing elements, and/or Brabender mixer. An example of a suitable system is the continuous single shafted Extrudomix from Hosokawa, which is designed to mix solids and liquids. Suitable batch mixers can be horizontal or vertical mixing systems. Suitable industrial horizontal mixers have e.g. Z-shaped paddles or ploughshaped mixing elements. Preferred systems include intermeshing mixing elements that produce forced flow of the paste between the elements (e.g. horizontal Haake kneader). Industrial vertical mixers are commonly planetary mixers. A preferred system includes double planetary mixers or single planetary mixers with a counter current moving scraper, such as vertical mixer Tonnaer, or a system equipped with a mixing bowl turning around in opposite direction to the mixing element.

Processing the Concentrate into a Powder—Step f)

In accordance with the invention, a thermal drying treatment is carried out in order to produce a dry powder having a dry-matter content of more than 70 wt. %, preferably more than 75 wt. %, more than 80 wt. %, more than 85 wt. %, more than 87.5 wt. %, more than 90 wt. %, more than 92 wt. %, more than 93 wt. %, more than 94 wt. %, more than 95 wt. %, more than 96 wt. %, more than 97 wt. %, more than 98 wt. %, or more than 99 wt. %.

Generally speaking, materials of the invention can be dried using conventional industrial drying equipment such as a rotary dryer, static oven, fluidized bed, conduction dryer, convection dryer, conveyer oven, belt dryer, vacuum dryer, etc. Friction and heating exerted on the dried material during such operations can give rise to a substantial increase of the temperature of the blended product and can cause the temperature of the material to increase to a temperature wherein hornification of the cellulose material occurs. It has been found that much of these negative effects associated with conventional drying and further processing can be substantially avoided by carrying out step f) in such a way that the drying and milling/grinding step are performed in an integrated manner, i.e. in a single operation/apparatus. One apparatus that is particularly suitable to this end is an air turbulence mill. The use of an air turbulence mill results in simultaneous drying and milling or grinding of the material by feeding it, together with a flow of gas, generally air, to a high speed rotor in a confined chamber (stator). The rotor and inner walls of the stator are typically lined with impacting members. The rotor generally is placed vertically relative to the outlet. The air turbulence mill has the benefit of a fast grinding and drying-effect. Several types of air turbulence mills exist. They are generally referred to as turbulent air grinding mills, pneumatic mills, or vortex air mills. Some of these are also named ‘spin driers and grinders’, and others also ‘flash dryers and grinders’. Spin dryers-and-grinders and flash dryers and grinders basically dry and mill wet product in a very short period of time. Air turbulence mills, such as those known in the art from Atritor (Cell Mill), Hosokawa (Drymeister), Larsson (Whirl flash), Jackering (Ultra Rotor), Rotormill, Gorgens Mahltechnik (TurboRotor) or SPX may be used for drying and grinding in the present invention. Some of such air turbulence mills are described in e.g. U.S. Pat. No. 5,474,7550, WO1995/028512 and WO2015/136070. The air turbulence mill may comprise a classifier, which causes a separation of larger and smaller particles. The use of a classifier allows the larger particles to be returned to the grinder, while smaller particles are left through for further processing.

Hence, in accordance with the invention, it is particularly preferred that step f) comprises simultaneous drying and grinding of the concentrate as obtained in step e), preferably using an air turbulence mill. The step is typically performed with a stream of gas, generally air, with an inlet temperature generally ranging between about 100° C. and 200° C., preferably between about 120° C. and 190° C. and even more preferably between about 140° C. and 180° C. The higher end of the temperature may require careful processing and/or may require lower amounts of the heated gas to be used. The outlet temperature of the air generally is below 140° C., preferably below 120° C. The flow of the air generally is about 5 m³/h per kg of fed material or higher, preferably about 10 m³/h per kg fed material. Generally, the amount is about 50 m³/h or less, preferably about 40 m³/h per kg fed material or less. The gas flow can be fed into the mill directly with the feed material, or indirectly, wherein the feed material is fed on one place, and the gas stream is fed into the air turbulence mill separately in one or several other places. The rotor generally rotates with a tip speed of about 10 m/s or higher, more preferably of about 15 m/s or higher, even more preferably of about 20 m/s or higher. In one embodiment, generally, the speed is about 50 m/s or lower, preferably about 30 m/s or lower. Preferably the temperature of the material coming out of the air turbulence mill is at a temperature range between about 50° C. and 150° C., more preferably between about 60° C. and 125° C., even more preferably between about 70° C. and 100° C. It is possible to further classify the resultant powder leaving the mill, using, for example, a horizontal sieve for screening oversized, large particles and/or for removing dust. Reject of the sieve (oversized particles and/or dust) may be reintroduced in the feed for further treatment in the air turbulence mill, provided that the properties of the dried product are not adversely affected. Mixing of reject with the wet feed material (also referred to as “back mixing”) can improve the feeding operation and overall efficiency of the drying and grinding. Preferably, classification is done over a sieve (or other classification device) with the cut off of 1 mm or lower, preferably 800 μm or lower, more preferably 700 μm or lower. Classification can for example be done over a sieve with a cut off of 600 μm, 500 am or 400 μm.

The inventors established that good results can be also be accomplished using other drying and milling/grinding operation without exposure to heat, such as by subjecting the concentrate to cryomilling followed by freeze-drying, so as to produce a high DM, free-flowing powder composition.

As will be understood by those skilled in the art based on the present teachings, the exact conditions needed to achieve the target water level will depend, amongst others, on the water content of the concentrate before drying, on the exact nature of the material, etc. It is within the capabilities of those of average skill in the art, based on the present teachings, to carry out the process taking account of these variables and without excessively exposing the material to temperatures above the critical value/range at which substantial hornification and/or crystallization occurs.

### Product Obtainable by the Method

In accordance with embodiments of the invention, the powder composition of the invention are free flowing, meaning that the powder can be poured from a container in a continuous flow in which substantially the same mass leaves the container in the same time interval. In contrast, non-free-flowing materials will clump together to form aggregates of undefined size and weight and therefore cannot be poured from the container in a continuous flow in which substantially the same mass leaves the container in the same time interval. In embodiments of the invention at least 90% of separate and individual particles will remain separate and individual in a bulk container when stored over a period of 24 hours at ambient temperature and humidity (25° C. and 50% relative humidity).

Powder compositions can further be characterized by specific D10, D50 and D90 values. D10 is the particle size value that 10% of the population of particles lies below. D50 is the particle size value that 50% of the population lies below and 50% of the population lies above. D50 is also known as the median value. D90 is the particle size value that 90% of the population lies below. A powder composition that has a wide particle size distribution will have a large difference between D10 and D90 values. Likewise, a powder composition that has a narrow particle size distribution will have a small difference between D10 and D90. Particle size distribution may suitably be determined by using conventional tapped sieves. In embodiments of the invention a powder composition as defined herein is provided having a D50 of less than 800 μm, more preferably of less than 500 μm or less than 300 μm. In embodiments of the invention a powder composition as defined herein is provided having a D50 of more than 10 μm, more preferably of more than 20 μm or more than 50 μm. In an embodiment the D50 is in between 75 and 40 μm. In embodiments of the invention a powder composition as defined herein is provided having a D90 of less than 2000, 1500, or 1000 μm or less than 750 μm. In embodiments of the invention a powder composition as defined herein is provided having a D90 of more than 5 μm, more preferably of more than 10 μm or more than 20 μm. In embodiments of the invention a powder composition as defined herein is provided having a D10 of less than 1000, 500. 250 or 200 μm or less than 150 μm. In embodiments of the invention a powder composition as defined herein is provided having a D50 of more than 25 μm, more preferably of more than 50 am or more than 75 μm. In embodiments of the invention the D90 is no more than 400, 200 or 150% greater than D10, or no more than 100% greater than D10.

As will be understood by those skilled in the art on the basis of the present disclosure, it is a particular advantage of the present invention that suitable powder compositions can be provided having a low water content. In embodiments of the invention, the powder composition according to the present invention has a water content of less than 30 wt. %, less than 25 wt. %, less than 20 wt. %, less than 15 wt. %, less than 12.5 wt. %, less than 10 wt. %, less than 8 wt. %, less than 7 wt. %, less than 6 wt. % or less than 5 wt. %. Such powders are economically transported and handled. In embodiments of the invention, the powder composition comprises more than 70 wt. % of dry matter, preferably more than 75 wt. %, more than 80 wt. %, more than 85 wt. %, more than 87.5 wt. %, more than 90 wt. %, more than 92 wt. %, more than 93 wt. %, more than 94 wt. % or less than 95 wt. %. In embodiments of the invention, the powder composition comprises up to 99.9, 99.5, 99, 98, 97, or 95 wt. % of dry matter.

It was surprisingly found that powder compositions in accordance with the invention are not only easily dispersed, while still being able to provide the desired rheological effect, but also have a low water activity. This has the particular advantage that the powder compositions will have good microbial stability. A preferred method for determining the water activity of a sample is to bring a quantity of the sample in a closed chamber having a relatively small volume, measuring the relative humidity as a function of time until the relative humidity has become constant (for instance after 30 minutes), the latter being the equilibrium relative humidity for that sample. Preferably, a Novasina TH200 Thermoconstanter is used, of which the sample holder has a volume of 12 ml and which is filled with 3 g of sample. In embodiments of the invention, powder compositions as defined herein are provided having a water activity (Aw), defined as the equilibrium relative humidity divided by 100%, of less than 0.7, less than 0.6, less than 0.5, less than 0.4 or less than 0.3.

The surprising low water activity of the powders allows them to be made, shipped and used without the need to add preservatives, such as biocides. This has advantages not only from an ecological perspective but also allows the use of the powders, or dispersions thereof in applications wherein preservatives are undesired. Accordingly, embodiments of the invention are also provided wherein the powder composition is substantially or entirely free from preservatives, e.g. the powder contains less than 2.5 wt. %, based on total dry weight, of preservatives, preferably less than 1.5 wt. %, less than 1 wt. %, less than 0.5 wt. %, less than 0.25 wt. %, less than 0.1 wt. %, less than 0.05 wt. %, less than 0.01 wt. % or about 0 wt. %.

If so desired, the powder composition may also comprise additional salts, for instance to influence redispersion rates, particularly when cross-linked nonionic cellulose ethers were used. However, also additives may be comprised in the product, such as colorants, pigments, anti-caking agents, surfactants, and the like. If present such additives may be introduced into the product at any time. Suitably they are combined with the FC and nonionic cellulose just before or after the drying/grinding step. If present, these additives are typically present in an amount less than 25 or 10% w/w.

As will be evident from the foregoing, a particular advantage of the powder compositions of the present invention is that they can be dispersed in water or aqueous systems without having to apply high-intensity mechanical treatment to form a homogenous structured system.

Typically, in accordance with the invention, these beneficial properties can be established using simple testing methods. In particular, the compositions of the invention can be dispersed at a concentration of the cellulose component of 1 wt. % (w/v) in water by mixing a corresponding amount of the powder in 200 ml of water in a 400 ml beaker having a 70 mm diameter (ex Duran) and a propeller stirrer equipped with three paddle blades each having a radius of 45 mm, for instance a R 1381 3-bladed propeller stirrer ex IKA (Stirrer Ø: 45 mm Shaft Ø: 8 mm Shaft length: 350 mm), placed 10 mm above the bottom surface and operated at 700 rpm for 120 minutes, at 25° C. With such a set-up, the “easy to disperse” powder composition will be completely dispersed within the 120 minutes, at 25° C., where completely dispersed means that no solids or lumps can be visually distinguished anymore. Furthermore, a dispersion of the present composition in water, at a concentration of the cellulose component of 1% (w/v) prepared using this particular protocol has one or more of the rheological characteristics described in the subsequent paragraphs.

In embodiments of the invention, a dispersion of the present composition in water, at a concentration of the cellulose component of 1% (w/v), obtained using the above described re-dispersion protocol shows no syneresis after standing for 16 hours at 25° C. in a 200 ml graduated cylinder of about 300 mm height. Within the context of the present invention, no syneresis means that if a layer of water is formed on top of the dispersion it is less than 1 mm or that no such layer of water is distinguishable at all.

The structured system obtained when dispersing the composition at a concentration of the cellulose component of 1% (w/v) in water, according to the above described re-dispersion protocol, typically will take the form of a viscoelastic system or a gel. Typically, the viscoelastic behavior of these systems can be further determined and quantified using dynamic mechanical analysis where an oscillatory force (stress) is applied to a material and the resulting displacement (strain) is measured. The term “Storage modulus”, G′, also known as “elastic modulus”, which is a function of the applied oscillating frequency, is defined as the stress in phase with the strain in a sinusoidal deformation divided by the strain; while the term “Viscous modulus”, G″, also known as “loss modulus”, which is also a function of the applied oscillating frequency, is defined as the stress 90 degrees out of phase with the strain divided by the strain. Both these moduli, are well known within the art, for example, as discussed by G. Marin in “Oscillatory Rheometry”, Chapter 10 of the book on Rheological Measurement, edited by A. A. Collyer and D. W. Clegg, Elsevier, 1988. In the art, gels are defined to be those systems for which G′>G″.

In embodiments of the invention, a dispersion of the present composition in water, at a concentration of the cellulose component of 1% (w/v), obtained using the above described re-dispersion protocol, has a storage modulus G′ of at least 25, 50, 75, 90, or 100 Pa, more preferably at least 110 Pa, at least 120 Pa, at least 130 Pa, at least 140 Pa or at least 150 Pa. In embodiments of the invention the storage modulus G′ of said dispersion is 500 Pa or less, e.g. 400 Pa or less, or 300 Pa or less.

In embodiments of the invention, a dispersion of the present composition in water, at a concentration of the cellulose component of 1% (w/v), obtained using the above described re-dispersion protocol has a storage modulus G′ that is higher than the loss modulus G″ over the whole length of the linear viscoelastic region. More preferably a dispersion of the present powder composition in water, at a concentration of the cellulose component of 1% (w/v), obtained using the above described protocol, has a loss modulus G″ of at least 10 Pa, more preferably at least, 12.5 Pa, at least 15 Pa, at least 17.5 Pa or at least 20 Pa. In embodiments of the invention the loss modulus G″ of said dispersion is 100 Pa or less, e.g. 75 Pa or less, or 50 Pa or less.

In embodiments of the invention, a dispersion of the present composition in water, at a concentration of the cellulose component of 1% (w/v), obtained using the above described re-dispersion protocol has a flow point (at which G′=G″) of at least 10 Pa, more preferably at least, 12.5 Pa, at least 15 Pa, at least 17.5 Pa or at least 20 Pa. In embodiments of the invention the flow point of said dispersion is 75 Pa or less, e.g. 50 Pa or less, or 30 Pa or less. The flow point is the critical shear stress value above which a sample rheologically behaves like a liquid; below the flow point it shows elastic or viscoelastic behavior.

In an embodiment of the invention, a dispersion of the present composition in water, at a concentration of the cellulose component of 1% (w/v), obtained using the above described re-dispersion protocol has a yield point of at least 1 Pa, preferably at least 1.5 Pa, at least 2.0 Pa, at least 2.5 Pa or at least 3 Pa. In embodiments of the invention the yield point of said dispersion is 10 Pa or less, e.g. 7 Pa or less, 6 Pa or less or 5 Pa or less. The yield point is the lowest shear stress, above which elastic deformation behavior ends and visco-elastic or viscous flow starts occurring; below the yield point it shows reversible elastic or viscoelastic behavior. Between the yield point and the flow point is the yield zone.

In an embodiment of the invention, a dispersion of the present composition in water, at a concentration of the cellulose component of 1% (w/v), obtained using the above described re-dispersion protocol, has a viscosity at 0.01s⁻¹ of at least 150 Pa·s, preferably at least 200 Pa·s, at least 250 Pa·s or at least 300 Pa·s. In embodiments of the invention said dispersion typically has a viscosity at 0.01 s⁻¹ of 750 Pa·s or less, e.g. 600 Pa·s or less or 500 Pa·s or less.

In embodiments of the invention, a dispersion of the present composition in water, at a concentration of the cellulose component of 1% (w/v), obtained using the above described re-dispersion protocol is shear thinning. Shear thinning, as used herein, means that the fluid's resistance to flow decreases with an increase in applied shear stress. Shear thinning is also referred to in the art as pseudoplastic behavior or thixotropic behavior. Shear thinning can be quantified by the so called “shear thinning factor” (SF) which is obtained as the ratio of viscosity at 1 s⁻¹ and at 10 s⁻¹: A shear thinning factor below zero (SF<0) indicates shear thickening, a shear thinning factor of zero (SF=0) indicates Newtonian behavior and a shear thinning factor above zero (SF>0) stands for shear thinning behavior. In an embodiment of the invention the shear thinning property is characterized by the structured system having a specific pouring viscosity, a specific low-stress viscosity, and a specific ratio of these two viscosity values.

In embodiments of the invention, a dispersion of the present composition in water, at a concentration of the cellulose component of 1% (w/v), obtained using the above described protocol has a pouring viscosity ranging from 25 to 2500 mPa·s, preferably from 50 to 1500 mPa·s, more preferably from 100 to 1000 mPa·s. The pouring viscosity, as defined here, is measured at a shear rate of 20 s⁻¹.

As will be understood by those skilled in the art, rheological characteristics of the re-dispersed powder composition, determined in accordance with above-defined protocol, can be compared with that of a dispersion of a corresponding combination of the cellulose component and the nonionic cellulose ether before/without drying into a powder, so as to assess the extent to which the rheological performance is regained after drying and re-dispersion according to the present invention.

Accordingly, embodiments are provided, wherein the storage modulus G′ of a re-dispersed powder composition, determined in accordance with above-defined protocol, is X, whereby the storage modulus G′ of an aqueous dispersion of the corresponding combination of the cellulose component and the nonionic cellulose ether without/before drying is less than 2X, preferably less than 1.75X, more preferably less than 1.5X, more preferably less than 1.4X, more preferably less than 1.3X, more preferably less than 1.2X, more preferably less than 1.1X. For such powder compositions the remarkable good rheological property retention, when compared to the composition before drying, allows an economic handling of the composition without that undesired laborious and energy-intensive activation processes are needed.

Furthermore, embodiments are provided, wherein the Yield Point of a re-dispersed powder composition, determined in accordance with above-defined protocol, is Y whereby the yield point of an aqueous dispersion of the corresponding combination of the cellulose component and the nonionic cellulose ether without/before drying is less than 2Y, preferably less than 1.75Y, more preferably less than 1.5Y, more preferably less than 1.4Y, more preferably less than 1.3Y, more preferably less than 1.2Y, more preferably less than 1.1 Y.

Furthermore, embodiments are provided, wherein the viscosity of a re-dispersed powder composition, determined in accordance with above-defined protocol, is Z whereby the viscosity of an aqueous dispersion of the corresponding combination of the cellulose component and the nonionic cellulose ether without/before drying is less than 2Z, preferably less than 1.75Z, more preferably less than 1.5Z, more preferably less than 1.4Z, more preferably less than 1.3Z, more preferably less than 1.2Z, more preferably less than 1.1Z.

Particularly preferred embodiments are provided, wherein a dispersion of the present powder composition in water, at a concentration of the cellulose component of 1% (w/v), obtained using the above described protocol, has a the viscosity at a shear-rate of 0.01 s⁻¹, determined in accordance with above-defined protocol, of Q, whereby an aqueous dispersion of the corresponding combination of the cellulose component and the nonionic cellulose ether (at a concentration of the cellulose component of 1% (w/v)), without/before drying has a viscosity at a shear-rate of 0.01 s⁻¹ of less than 20, preferably less than 1.75Q, more preferably less than 1.5Q, more preferably less than 1.4Q, more preferably less than 1.3Q, more preferably less than 1.2Q, more preferably less than 1.1Q.

Unless indicated otherwise, viscosity and flow behavior measurements, in accordance with this invention, are performed at 20° C., using an Anton Paar rheometer, Physica MCR 301, with a 50 mm plate-plate geometry (PP50) and a gap of 1 mm. For amplitude sweep testing the angular frequency is fixed at 10 s⁻¹ and the strain amplitude (y) is from 0.01% to 500%.

### Applications of the Product of the Invention

The present invention concerns the use of the compositions as defined in the foregoing and/or as obtainable by any of the methods described in the forgoing as a dispersable or redispersible composition and which are easy to disperse. In particular the present invention provides the use of the composition as defined in the foregoing and/or as obtainable by any of the methods described in the forgoing to provide a structured fluid water based composition such as a (structured) suspension or dispersion or a hydrogel. Particularly in such compositions, the thixotropic behavior of the composition is desirable. The term “fluid water based composition” as used herein refers to water based compositions having fluid or flowable characteristics, such as a liquid or a paste. Fluid water based compositions encompass aqueous suspensions and dispersions. Gels, in accordance with the invention, are structured aqueous systems for which G′>G″, as explained herein before.

The fluid water based composition and hydrogels of the invention have water as the main solvent. Fluid water based composition may further comprise other solvents.

The fluid water based composition or hydrogel comprising the powder composition according to the present invention is suitable in many applications or industry, in particular as an additive, e.g. as a dispersing agent, structuring agent, stabilizing agent or rheology modifying agent. In an embodiment the fluid water based compositions are used because they are salt tolerant and temperature stable, meaning they can be used in more applications, such as in paints and mortars and handled more easily, i.e. allow processing at elevated temperatures, than conventional compositions not comprising the FC and nonionic cellulose ether. Suitably they are used in aqueous media comprising 1, 2, 3, 5, or 10% w/w or more of salt.

Fluid water based compositions may comprise the powder composition in sufficient quantities to provide a concentration of the cellulose component ranging between 0.01 or 0.02% (w/v) and 5% (w/v), more preferably ranging between 0.05 or 0.10, or 0.25, or 0.5, or 0.75 and 3, or 2, or 1.5% (w/v).

The compositions as defined in the foregoing and/or as obtainable by any of the methods described in the forgoing are in particular suitable to be used in detergent formulations, for example dishwasher and laundry formulations; in personal care and cosmetic products, such as hair conditioners and hair styling products; in fabric care formulations, such as fabric softeners; in paint and coating formulations, such as for example water-born acrylic paint formulations; food and feed compositions, such as beverages, frozen products and cultured dairy; pesticide formulations; biomedical products, such as wound dressings; construction products, as for example in asphalt, concrete, mortar and spray plaster, for example useful in 3D printing of mortar; adhesives; inks; de-icing fluids; fluids for the oil & gas industry, such drilling-, fracking- and completion fluids; paper & cardboard or non-woven products; pharmaceutical products.

Embodiments are also envisaged, wherein the powder composition of the present invention is used to improve mechanical strength, mechanical resistance and/or scratch resistance in ceramics, ceramic bodies, composites, and the like.

In another aspect, the invention provides uses of the compositions as defined herein in accordance with what has been discussed elsewhere. Hence, as will be understood by those skilled in the art, based on the present disclosure, specific embodiments of the invention relate to the use of a composition as defined herein, including a composition obtainable by the methods as defined herein, for modifying one or more rheological properties of a water-based formulation and/or as a structuring agent in a water-based formulation. In an embodiment of the invention uses are provided for modifying one or more rheological properties of a water-based formulation and/or as a structuring agent in a water-based formulation. In an embodiment of the invention uses are provided for conferring the rheological properties according to what is defined here above (to characterize the product of the invention per se).

In another aspect of the invention, methods are provided for producing an aqueous structured formulation, such as the formulations described here above, said process comprising adding the compositions as defined in the foregoing and/or as obtainable by any of the methods described in the forgoing. Such methods will further typically comprise steps to homogeneously blend the powder composition and an aqueous formulation. In some embodiments of the invention, such methods comprise the step of mixing with an industrial standard impeller like a marine propeller, hydrofoil or pitch blade which can be placed with top, side or bottom entry. The method preferably does not involve the use of high speed impellers like tooth saw blades, dissolvers, deflocculating paddles and/or the use of equipment exerting high shear treatment, using for instance rotor-rotor or rotor-stator mixers. In embodiments of the invention, the method does not involve the use of equipment exerting shear in excess of 1000 s⁻¹, in excess of 500 s⁻¹, or in excess of 250 s⁻¹ or in excess of 100 s⁻¹.

In another aspect of the invention, methods are provided for improving one or more properties of an aqueous formulation, such as the formulations described here above, said process comprising incorporating into the formulation, the compositions as defined in the foregoing and/or as obtainable by any of the methods described in the forgoing.

Thus, the invention has been described by reference to certain embodiments discussed above. It will be recognized that these embodiments are susceptible to various modifications and alternative forms well known to those of skill in the art. Many modifications in addition to those described above may be made to the structures and techniques described herein without departing from the spirit and scope of the invention. Furthermore, for a proper understanding of this document and its claims, it is to be understood that the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the elements is present, unless the context clearly requires that there be one and only one of the elements. The indefinite article “a” or “an” thus usually means “at least one”. The term “consisting” wherever used herein also embraces “consisting substantially”, but may optionally be limited to its strict meaning of “consisting entirely”. Where upper and lower limits are quoted for a property, for example the Mw, then a range of values defined by a combination of any of the upper limits with any of the lower limits may also be implied. It should be appreciated that the various aspects and embodiments of the detailed description as disclosed herein are illustrative of the specific ways to make and use the invention and do not limit the scope of invention when taken into consideration with the claims and the detailed description. It will also be appreciated that features from different aspects and embodiments of the invention may be combined with features from any other aspects and embodiments of the invention.

The following examples are offered for illustrative purposes only, and are not intended to limit the scope of the present invention in any way.

### EXAMPLES

### Example 1: Processing of Sugar Beet Pulp

A batch of 200 kg of ensilaged sugar beet pulp is washed by a flotation washer and a drum washer to remove all non-sugar beet pulp items (sand, stones, wood, plastic). After washing 249 kg of sugar beet pulp is diluted with 341 kg of process water to a total weight of 600 kg. This mass is heated up to 80° C. under continuous slow mixing. When 80° C. is reached 1% (w/w) sulfuric acid is added. During 180 minutes this mass is slowly mixed while the pH is about 1.5. After 180 minutes the mass is pumped into a chamber filter press to remove most of the water including a part of the protein, hemicellulose and pectins. The filtrate is pumped to the sewage or recycled and the pressed cake is transported to the alkali extraction tank. 78 kg pressed cake is diluted with process water to a total weight of 600 kg. The DM content after dilution is 2.59% (w/w). This mass is heated up to 40° C. and then 1% (w/w) NaOH is added to reach a pH of about 11. The mixture is then heated up to 95° C. and during 30 minutes slowly mixed and during 30 minutes high shear mixed by a Silverson FX mixer to reach smooth and lump free texture. This mixture is the cooled down to 80° C. and subsequently pumped into a chamber filter press to remove most of the water including the alkali soluble part of the protein, hemicellulose and pectins. The filtrate is pumped to the sewage or recycled and the pressed cake is again taken up into process water of ambient temperature to a dry matter content of 1.5%.

If used, a cellulose ether (obtained from Nouryon) was added in a ratio (w/w) of the cellulose component and cellulose ether of 95:5. After complete mixing (overnight) the resulting suspension is pumped to a to high pressure homogenizer (GEA Niro Soavi Ariete NS3024H, Y:2012, P: 35 MPa, Q: 1600 L/h, Serial: 947.1) and homogenized 5 times at 150 bar.

The homogenized mass is transferred to a filter press (Tefsa filter press HPL, 630×630 mm, 16 bar, serial PT-99576, filter cloth Tefsa CM-275) and pressed to approx. 8% dry matter at 2.2 bar filter pressure. A sample is drawn from the material thus obtained (referred to as BF).

The rheology of a 1% dry weight solution of BF was compared with the rheology of solutions in which a blend of 1% by weight of dry BF and 1% by weight of a nonionic cellulose ether was used. In a comparative example CMC of the type Akucell® AF 0305 ex Nouryon was used, and in the example according to the invention the product. The rheological properties were determined using a TA Instruments Discovery HR-2 rheometer with a 40 mm cone-plate with an angle of 4° at 25° C.

| | G′ | G′ = G″ | η₀ | η_{10 s} | η_{60 s} | t_{50%} | η-rel_{10 s} | η-rel_{60 s} |
|---|---|---|---|---|---|---|---|---|
| | (Pa) | (Pa) | (Pa · s) | (Pa · s) | (Pa · s) | (s) | (%) | (%) |
| 1% BF | 246 | 12 | 70 | 70 | 70 | <2 | 100 | 100 |
| 1% BF + 1% | 59 | 9.1 | 36 | 32 | 36 | <2 | 89 | 100 |
| Akucell AF 0305 | | | | | | | | |
| 1% BF + 1% | 122 | 22 | 81 | 13 | 26 | 163 | 16 | 32 |
| Bermocoll M5 | | | | | | | | |

The results show that using a non-ionic cellulose ether with a Mw greater than 100 kD shows unexpected thixotropic behavior and it was found that such combinations can be advantageous when the products are used as thickener in paints or mortars.

It is noted that in the table G′ is the storage modulus, G′=G″ is the flow point and the other parameters are expressions of thixotropy. I.e. no is the baseline viscosity reached after 120 s at 0.1 s⁻¹, η₁₀ η₆₀ viscosity is the viscosity measured after treating the formulation for 30 s at high shear (200 s⁻¹) and subsequently 10 and 60 s, respectively, at low shear of 0.1 s⁻¹, with t_{50%} being the time it takes to recover 50% from η₀, and η-rel₁₀ₛ and η-rel₆₀ₛ showing how much of the baseline viscosity was recovered after 10 and 60 s, respectively, under low shear conditions.

After drying the blend of BF and Bermocoll M5 to a dry powder in a pneumatic drying mill ex Jäckering, the resulting product was easy to disperse, also in salt water.

### Example 2

In the following example mixtures of example 1, with slightly different concentrations of the ingredients were evaluated for their rheological performance in water and a salt solution containing 10% by weight of NaCl, by measuring the G′. A comparative 1.3% BF/AF0305 70/30 dispersion in water gave a good G′ but in salt water the resulting G′ was unsatisfactory.

| | | % | G′ of | G′ of 10 |
|---|---|---|---|---|
| | Shear | BF | Water | % NaCl |
| 1% BF | high | 1 | 246 | 226 |
| 2.6% BF/M5 50/50 | low | 1.3 | 185 | 149 |
| 4% BF/0305 50/50 | low | 2 | 747 | 603 |

The results show that the use of FC and nonionic cellulose ether leads to formulations that also provide rheological properties to aqueous media that comprise salt.

### Example 3

In the following example a typical paint formulation was made. In examples of the invention mixtures of an FC of example 1 and a nonionic cellulose ex Nouryon, i.e. Bermocoll M10 were used to replace part of a typical HEUR thickener. The HEUR thickener is typically used in the formulation to control sagging and leveling. It was replaced by water and a lower quantity of the FC/M10 mixture.

| Example | Ref | 3a | 3b | 3c |
|---|---|---|---|---|
| Water | 54.9 | 56.9 | 56.4 | 55.9 |
| Byk* 022 | 0.5 | 0.5 | 0.5 | 0.5 |
| Dispex* AA 4140 | 2.5 | 2.5 | 2.5 | 2.5 |
| Propylene glycol | 32 | 32 | 32 | 32 |
| AMP* | 0.1 | 01 | 0.1 | 0.1 |
| Kronos*190 | 140 | 140 | 140 | 140 |
| Mowolith* LDM 1871 | 260 | 260 | 260 | 260 |
| Kathon* LXE | 0.5 | 0.5 | 0.5 | 0.5 |
| Byk* 1785 | 1.5 | 1.5 | 1.5 | 1.5 |
| Acrysol* RM8-W | 10 | 5 | 5 | 5 |
| FC/M10 | 0 | 1 | 1.5 | 2 |

*=
Byk ® 022 is a product of Altana
Dispex ® AA 4140 is a product of BASF
AMP ® is a dispersant ex Angus Chemical Company
Kronos ® 2190 is a titanium dioxide ex Kronos
Mowolith ® LDM 1871 is a VAE-based binder ex Celanese
Kathon ® LXE is a preservative ex DuPont
Byk ® 1785 is a defoamer ex Altana
Acrysol ® RM8-W is a HEUR thickener ex Dow

Evaluation of the Paint

| Example | Ref | 3a | 3b | 3c |
|---|---|---|---|---|
| Stormer viscosity (KU) | 94 | 94 | 98 | 102 |
| ICI cone plate viscosity (P) | 1.172 | 0.965 | 1.095 | 1.277 |
| Sagging (24 is max is best) | 10 | 24 | 24 | 24 |
| Leveling (higher is better) | 8 | 3 | 7 | 8 |

After drying the blend of FC and Bermocoll M10 to a dry powder in a pneumatic drying mill ex Jäckering, the resulting product was easy to disperse, also in salt water.

The results show that the rheological properties were exceptionally good. The same leveling was observed, without that any sagging was observed.

1. Compositions comprising fibrillated cellulose and a nonionic cellulose ether.

2. Compositions of claim 1 comprising fibrillated cellulose and a nonionic cellulose ether in a weight ratio from 90/10 to 10/90, which is preferably free-flowing.

3. Compositions of claim 1 wherein the composition consists for more than 50% by weight of fibrillated cellulose and nonionic cellulose ether.

4. Compositions of claim 1 wherein the nonionic cellulose ether is selected from ethyl hydroxyethyl cellulose, methyl ethyl hydroxyethyl cellulose, hydroxyethyl cellulose, methyl hydroxyethyl cellulose, methyl hydroxypropyl cellulose, the hydrophobically modified derivatives thereof, and mixtures thereof.

5. Compositions of claim 1 that result in thixotropic compositions when dispersed in an aqueous medium.

6. Process of producing a composition of claim 1 comprising the steps of:
a) providing a mixture of an aqueous liquid and a cellulose material;
b) optionally blending a quantity of carboxycellulose and/or nonionic cellulose ether with the mixture;
c) subjecting the mixture or slurry obtained in step b) to mechanical/physical and/or enzymatic activation/fibrillation treatment to create fibrillated cellulose;
d) concentrating the composition obtained in step c) to a dry matter content of at least 5 wt. %, preferably at least 10 wt. %, more preferably at least 20 wt. %;
e) optionally further blending a further quantity of the nonionic cellulose ether with the composition as obtained in step d) so that the final ratio (on a dry weight basis) of cellulose and nonionic cellulose ether is within the range of 90/10 to 10/90; and
f) processing the concentrate into a powder by subjecting it to a simultaneous thermal drying and milling/grinding operation to form a dry powder,
whereby steps d) and e) can be in any order and whereby the nonionic cellulose ether is added in step b) or e) or both.

7. Process according to claim 6, wherein the nonionic cellulose ether is dissolved in water before being blended with the aqueous slurry.

8. Process according to claim 6, wherein, in step c), the cellulose is subjected to a high mechanical shear process, so as to produce fibrillated cellulose.

9. Process according to claim 8, wherein, in step c), the cellulose is subjected to a high mechanical shear process, so as to produce a composition having a D[4,3] within the range of 25-75 μm, as measured by laser diffractometer.

10. Process according to claim 6, wherein step d) comprises a mechanical or non-thermal de-watering treatment, preferably a de-watering treatment using a filter press.

11. Process according to claim 6, wherein in steps b) and step e) a total quantity of nonionic cellulose ether is used such that the ratio (w/w) of the fibrillated cellulose component and the nonionic cellulose ether is within the range of 90/10 to 10/90.

12. Process according to claim 6, wherein step f) comprises processing the concurrent drying and grinding of the concentrate as obtained in step e) using an air turbulence mill.

13.-14. (canceled)

15. Method of modifying the rheology of an aqueous formulation comprising the step of dispersing a composition as defined in claim 1 in said formulation, wherein said method does not involve the use of equipment exerting shear in excess of 1000 s⁻¹.
